(19) United States
(12) Patent Application Publication
(10) Pub. No.: US 2007/0208089 A1
(43) Pub. Date: Sep. 6, 2007

(54) PSEUDOPLASTIC, AQUEOUS DISPERSIONS, METHOD FOR THEIR PRODUCTION AND USE THEREOF

(75) Inventors: Andreas Poppe, Sendenhorst (DE); Berthold Austrup, Nordkirchen (DE); Hubert Baumgart, Munster (DE)

Correspondence Address: BASF CORPORATION;Patent Department, 1609 BIDDLE AVENUE, MAIN BUILDING, WYANDOTTE, MI, 48192, US

(73) Assignee: BASF Corporation Patent/Legal Department, Southfield, MI (US)

(21) Appl. No.: 10/595,498

(22) PCT Filed: Oct. 27, 2004
(86) PCT No.: PCT/EP04/52817

§ 371 Date: Jan. 26, 2007

(30) Foreign Application Priority Data
Nov. 3, 2003 (DE) 103 51 251.9

(51) Int. Cl. C09D 5/02; C08G 18/80; C09C 1/30; C09D 175/04

(52) U.S. Cl. 516/77

(57) ABSTRACT

Pseudoplastic aqueous dispersions comprising particles which are solid and/or of high viscosity, are dimensionally stable under storage and application conditions, are in dispersion in a continuous aqueous phase and said particles comprise surface-modified nanoparticles whose surface is covered fully or almost fully by modifying groups, processes for preparing them, and their use

The present invention relates to novel pseudoplastic aqueous dispersions The present invention also relates to a novel process for preparing pseudoplastic aqueous dispersions. The present invention further relates to the use of the novel pseudoplastic aqueous dispersions and of the pseudoplastic aqueous dispersions prepared by means of the novel process as coating materials, adhesives, and sealants for the coating, adhesive bonding, and sealing of bodies of means of transport and parts thereof, constructions and parts thereof, doors, windows, furniture, small industrial parts, mechanical, optical, and electronic components, coils, containers, packaging, hollow glassware, and articles of everyday use.

Pseudoplastic aqueous dispersions comprising particles which are solid and/or of high viscosity and are dimensionally stable under storage and application conditions, in a continuous aqueous phase, are known for example from German patent applications DE 100 27 292 A1 or DE 101 35 997 A1 (cf. in this respect in particular DE 100 27 292 A1, page 2, para. [0013] to page 3, para. [0019], or DE 101 35 997, page 4, paras. [0034] to [0041]). The pseudoplastic aqueous dispersions are also referred to as powder slurries. They can be used outstandingly as coating materials, adhesives, and sealants, especially as coating materials, specifically as powder slurry clearcoat materials. Like liquid coating materials they can be applied by spray application. The drying and curing characteristics of the resultant films are similar, however, to those of powder coating films, i.e., film formation and curing take place in two discrete stages. Not least, as with the powder coating materials, no volatile organic solvents are released during application, film formation or curing. In short, the powder slurries unite key advantages of liquid coating materials and powder coating materials, so making them particularly advantageous.

Powder slurries comprising nanoparticles are known from German patent applications DE 100 27 267 A1, DE 100 27 290 A1, DE 100 27 292 A1, DE 101 15 605A1 or DE 101 26 649A1. The known powder slurries provide opaque and transparent coatings which exhibit a very good profile of performance properties and can be employed widely. In order to satisfy the constantly rising requirements of the market, especially of the automobile industry, however, it is necessary for the surface hardness, scratch resistance, and polishability of the opaque and transparent coatings to be improved further Above all, however, these properties must be improved further in clear and transparent coatings, especially in clearcoats, without detriment to the leveling, gloss, clarity, transparency or chemical resistance.

The present invention was based on the object of finding novel pseudoplastic aqueous dispersions, especially powder slurries, which no longer have the disadvantages of the prior art but which instead can be prepared simply and very reproducibly and which are stable in transmit and on storage.

The novel pseudoplastic aqueous dispersions, especially the powder slurries, ought to be capable of broad application. In particular they ought to be suitable for use as coating materials, adhesives, and sealants for producing coatings, adhesive layers, and seals. The intention is in particular that they serve as coating materials for producing opaque and transparent coatings, especially clear, transparent coatings.

The novel coatings, paint systems, adhesive layers, and seals ought not only to be scratch-resistant, hard, and polishable but also chemical- and acid-resistant. Moreover, the novel coatings, paint systems, adhesive layers, and seals ought if necessary to be completely transparent and clear and to exhibit no cloudiness or inhomogeneities. Their surface should additionally be smooth and free from surface defects.

The invention accordingly provides the novel pseudoplastic aqueous dispersions comprising particles (P) which are solid and/or of high viscosity, are dimensionally stable under storage and application conditions, are in dispersion in a continuous aqueous phase (W), and comprise surface-modified nanoparticles (N) whose surface is covered fully or almost fully by

(G1) modifying groups which

are attached covalently to the surface via functional linker groups (a) and
comprise functional reactive groups (c) which are attached via the groups (b) to the groups (a) and are inert toward the functional reactive groups of the surface to be modified, and
   (G2) modifying groups which
are attached to the surface via functional linker groups (a) containing at least one silicon atom,
comprise inert groups (e), and
have a smaller hydrodynamic volume V_{H} than the modifying groups (G1).

The novel pseudoplastic aqueous dispersions are referred to below as “dispersions of the invention”.

The invention further provides the novel process for preparing the dispersions of the invention, which involves mixing at least one dispersion (D) of surface-modified nanoparticles (N) whose surface is covered fully or almost fully by modifying groups (G1) and modifying groups (G2) in an aprotic, liquid, organic medium (O) with the remaining constituents of the dimensionally stable particles (P) and dispersing the resultant mixture (P) in an aqueous phase (W) so as to give the dimensionally stable particles (P).

The novel process for preparing the dispersions of the invention is referred to below as “preparation process of the invention”.

Additional subject matter of the invention will emerge from the description.

In the light of the prior art it was surprising and unforeseeable for the skilled worker that the object on which the present invention was based could be achieved by means of the dispersions of the invention and by means of the preparation process of the invention.

The dispersions of the invention, especially the powder slurries of the invention, were easy to prepare with great reproducibility, especially by means of the preparation process of the invention, and were stable in transmit and on storage.

The dispersions of the invention, especially the powder slurries of the invention, were capable of particularly broad application. Above all they were outstandingly suitable as coating materials, adhesives, and sealants for producing coatings, adhesive layers, and seals. In particular they were outstandingly suitable for use as coating materials for producing opaque and transparent coatings, especially clear, transparent coatings.

The opaque and transparent coatings, adhesive layers, and seals of the invention produced by means of the dispersions of the invention, especially the powder slurries of the invention, were not only highly scratch-resistant, very hard, and outstandingly polishable but were also extremely chemicals- and acid-resistant Moreover, the coatings, adhesive layers, and seals of the invention were, if needed, completely transparent and clear and had no clouding or inhomogeneities. Their surface, furthermore, was very smooth and entirely free from surface defects.

The dispersions of the invention comprise particles (P) which are solid and/or of high viscosity and are dimensionally stable under storage and application conditions. They are preferably the dimensionally stable particles (P) as defined in German patent application DE 100 27 292 A 1, page 2, paras. [0013] to [0015].

In the dispersions of the invention they are present preferably in an amount of from 5 to 70% by weight, more preferably from 10 to 65% by weight, very preferably from 10 to 60% by weight, and in particular from 10 to 55% by weight, based in each case on the dispersion of the invention. They preferably have the particle sizes described in German patent application DE 10027292 A1, page 3, paras. [0017] and [0018] and the solvent contents indicated on page 3, para. [0019].

The dimensionally stable particles (P) comprise the surface-modified nanoparticles (N) essential to the invention.

For the surface-modified nanoparticles (N) it is essential that their surface is covered fully or almost fully by modifying groups. “Covered fully or almost fully” means that the surface of the surface-modified nanoparticles (N) is covered to the extent permitted by the steric requirements of the individual modifying groups and that the reactive functional groups which may also be present on the surface of the nanoparticles of the invention are sterically screened and so prevented from entering into reactions with, say, polyisocyanates.

The surfaces of the surface-modified nanoparticles (N) are covered by at least two different classes of modifying groups (G1) and (G2). They may additionally be covered by modifying groups (G3).

The first class comprises modifying groups (G1) which are attached covalently to the surface via at least one, preferably at least two, and in particular three functional linker group(s) (G1a). The groups (G1a) are preferably inert under the conditions in which the nanoparticles of the invention are employed. The functional linker groups (G1a) more preferably contain at least one, especially one, silicon atom. Very preferably the functional linker groups (G1a) are silane groups.

The groups (G1) include at least one, especially one, inert spacer group (G1b).

“Inert” with respect to the group (G1b) means, here and below, that it does not enter into reactions under the conditions in which the surface-modified nanoparticles (N) are prepared and employed (cf. also Roempp Online, Georg Thieme Verlag, Stuttgart, N.Y., 2002, “inert”).

The inert spacer group (G1b) is preferably an at least divalent, especially divalent, organic radical R selected preferably from the group consisting of aliphatic, cycloaliphatic, aromatic, aliphatic-cycloaliphatic, aliphatic-aromatic, cycloaliphatic-aromatic and aliphatic-cycloaliphatic-aromatic radicals. The radicals R may contain more than one of said structural units.

The radicals R may further comprise at least one at least divalent, especially divalent, functional group and/or at least one substituent. It is essential that the divalent functional groups and the substituents are inert in the sense specified above. Suitable divalent functional groups are selected preferably from the group consisting of ether, thioether, carboxylate, thiocarboxylate, carbonate, thiocarbonate, phosphate, thiophosphate, phosphonate, thiophosphonate, phosphite, thiophosphite, sulfonate, amide, amine, thioamide, phosphoramide, thiophosphoramide, phosphonamide, thiophosphonamide, sulfonamide, imide, hydrazide, urethane, urea, thiourea, carbonyl, thiocarbonyl, sulfone, and sulfoxide groups. Ether groups are particularly preferred. Examples of suitable substituents are halogen atoms, especially fluorine atoms and chlorine atoms, nitrile groups, nitro groups or alkoxy groups. Preferably the radicals R are unsubstituted.

The modifying group (G1) further comprises at least one, especially one, functional reactive group (G1c) which is attached to the group (G1a) via the group (G1b) and which is inert, under the conditions in which the surface-modified nanoparticles (N) are prepared, toward the functional reactive groups of the surface to be modified (cf, also Roempp Online, Georg Thieme Verlag, Stuttgart, N.Y., 2002, “inert”). Under the conditions in which the nanoparticles of the invention are employed, however, the functional reactive group (G1c) is not inert but instead reactive, in particular it can be activated thermally and/or with actinic radiation so that it is able to enter into reactions initiated thermally and/or with actinic radiation, such as condensation reactions or addition reactions, which may proceed in accordance with radical, cationic or anionic mechanisms.

Here and below, actinic radiation means electromagnetic radiation, such as near infrared (NIR), visible light, UV radiation, X-rays or gamma radiation, especially UV radiation, and corpuscular radiation, such as alpha radiation, beta radiation, neutron beams, proton beams, and electron beams, especially electron beams.

Examples of suitable thermally activatable functional reactive groups (G1c) are epoxide groups and blocked isocyanate groups, especially blocked isocyanate groups of the general formula I:
—NH—C(X)—R¹ (I),
in which the variable X is an oxygen atom or a sulfur atom, in particular an oxygen atom, and the variable R¹ is the radical of a blocking agent such as is normally used for blocking isocyanate groups. Examples of suitable blocking agents are
i) phenols such as phenol, cresol, xylenol, nitrophenol, chlorophenol, ethylphenol, t-butylphenol, hydroxybenzoic acid, its esters or 2,5-di-tert-butyl-4-hydroxytoluene;
ii) lactams, such as ε-caprolactam, δ-valerolactam, γ-butyrolactam or β-propiolactam;
iii) active methylenic compounds, such as diethyl malonate, dimethyl malonate, methyl or ethyl acetoacetate or acetylacetone;
iv) alcohols such as methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, propylene glycol monomethyl ether, methoxymethanol, glycolic acid, glycolic esters, lacetic acid, lacetic esters, methylolurea, methylolmelamine, diacetone alcohol, ethylenechlorohydrin, ethylenebromohydrin, 1,3-dichloro-2-propanol, 1,4-cyclohexyldimethanol or acetocyanohydrin;
v) mercaptans such as butyl mercaptan, hexyl mercaptan, t-butyl mercaptan, t-dodecyl mercaptan, 2-mercaptobenzothiazole, thiophenol, methylthiophenol or ethylthiophenol;
vi) acid amides such as acetoanilide, acetoanisidinamide, acrylamide, methacrylamide, acetamide, stearamide or benzamide;
vii) imides such as succinimide, phthalimide or maleimide;
viii) amines such as diphenylamine, phenylnaphthylamine, xylidine, N-phenylxylidine, carbazole, aniline, naphthylamine, butylamine, dibutylamine or butylphenylamine;
ix) imidazoles such as imidazole or 2-ethylimidazole;
x) ureas such as urea, thiourea, ethyleneurea, ethylenethiourea or 1,3-diphenylurea;
xi) carbamates such as phenyl N-phenylcarbamate or 2-oxazolidone;
xii) imines such as ethyleneimine;
xiii) oximes such as acetone oxime, formaldoxime, acetaldoxime, acetoxime, methyl ethyl ketoxime, diisobutyl ketoxime, diacetyl monoxime, benzophenone oxime or chlorohexanone oximes;
xiv) salts of sulfurous acid such as sodium bisulfite or potassium bisulfite;
xv) hydroxamic esters such as benzyl methacrylohydroxamate (BMH) or allyl methacrylohydroxamate; or
xvi) substituted pyrazoles, especially dimethylpyrazoles, imidazoles or triazoles; and
xvii) mixtures of these blocking agents, especially dimethylpyrazole and succinimide.

Examples of suitable functional reactive groups (G1c) activatable with actinic radiation are groups which contain at least one, especially one, bond which can be activated with actinic radiation Examples of suitable bonds which can be activated with actinic radiation are carbon-hydrogen single bonds or carbon-carbon, carbon-oxygen, carbon-nitrogen, carbon-phosphorus or carbon-silicon single bonds or double bonds and carbon-carbon triple bonds. Of these the double bonds, especially the carbon-carbon double bonds (referred to as “double bonds” below), are employed with preference.

Highly suitable double bonds are present in, for example, (meth)acrylate, ethacrylate, crotonate, cinnamate, vinyl ether, vinyl ester, ethenylarylene, dicyclopentadienyl, norbornenyl, isopropenyl, allyl or butenyl groups; ethenylarylene ether, dicyclopentadienyl ether, norbornenyl ether, isopropenyl ether, allyl ether or butenyl ether groups; or ethenylarylene ester, dicyclopentadienyl ester, norbornenyl ester, isopropenyl ester, allyl ester or butenyl ester groups. Of these, (meth)acrylate groups, especially acrylate groups, are of particular advantage and are therefore used with very particular preference.

The second class comprises modifying groups (G2) which are attached covalently to the surface of the surface-modified nanoparticles (N) via at least one, especially one, functional linker group (G2a). The groups (G2a) are preferably inert under the conditions in which the surface-modified nanoparticles (N) are employed. The functional linker groups (G2a) preferably contain at least one, especially one, silicon atom. With particular preference the functional linker groups (G2a) are silane groups.

The modifying groups (G2) further comprise at least one, preferably at least two, and in particular at least three inert group(s) (G2e) linked to the surface via the group (G2a). The group (G2e) is, like the group (G1a) or the group (G3d) described below, inert under the conditions in which the surface-modified nanoparticles (N) are prepared and used. The groups (G2e) are preferably monovalent organic radicals R². They are preferably selected from the group consisting of aliphatic, cycloaliphatic, aromatic, aliphatic-cycloaliphatic, aliphatic-aromatic, cycloaliphatic-aromatic or aliphatic-cycloaliphatic-aromatic radicals. They may comprise the at least divalent functional groups and/or substituents described above

It is essential that the groups (G2) have a smaller hydrodynamic volume V_{H} than the modifying groups (G1). The hydrodynamic volume V_{H} can be determined by means of photon correlation spectroscopy or can be estimated from the relationship
V_{H}=(r_{cont}/2)³,
in which r_{cont} is the effective contour length of a molecule. For further details refer to the textbook by H.-G Elias, “Makromoleküle”, Hüthig & Wepf Verlag, Base1, volume 1, “Principles”, page 51.

The optional third class comprises modifying groups (G3) which are attached covalently to the surface of the surface-modified nanoparticles (N) via at least one functional linker group (G3a).

It is preferred to use groups (G3a) which are inert under the conditions in which the surface-modified nanoparticles (N) are employed. The groups (G3a) are preferably selected from the group consisting of ether, thioether, carboxylate, thiocarboxylate, carbonate, thiocarbonate, phosphate, thiophosphate, phosphonate, thiophosphonate, phosphite, thiophosphite, sulfonate, amide, amine, thioamide, phosphoramide, thiophosphoramide, phosphonamide, thiophosphonamide, sulfonamide, imide, hydrazide, urethane, urea, thiourea, carbonyl, thiocarbonyl, sulfone, and sulfoxide groups. Ether groups are particularly preferred.

The modifying groups (G3a) further comprise at least one, especially one, inert group (G3d) linked to the surface via the group (G3a). The group (G3d), like the group (G1b), is inert under the conditions in which the nanoparticles of the invention are prepared and used. The groups (G3d) are preferably monovalent organic radicals R². They are preferably selected from the group consisting of aliphatic, cycloaliphatic, aromatic, aliphatic-cycloaliphatic, aliphatic-aromatic, cycloaliphatic-aromatic or aliphatic-cycloaliphatic-aromatic radicals. They may comprise the at least divalent functional groups and/or substituents described above.

It is essential that the inert groups (G3d) have a smaller hydrodynamic volume V_{H} than the inert spacer groups (G1b).

The weight ratio between the modifying groups (G1) and (G2) can vary very widely and is guided by the requirements of the case in hand. The weight ratio is preferably from 200:1 to 1:10, more preferably from 100:1 to 1:5, and in particular from 50:1 to 1:1.

The surface-modified nanoparticles (N) can be prepared by the conventional methods of organic and of organosilicon chemistry, by subjecting, for example, suitable silanes having hydrolyzable groups to joint hydrolysis and condensation or by reacting nanoparticles that are to be modified with suitable organic compounds and silanes having hydrolyzable groups.

The surface-modified nanoparticles (N) are preferably prepared by the reaction of the functional reactive groups of the surface of nanoparticles (N′) to be modified with the below-described modifiers (M1) and (M2) and also, where appropriate, (M3). Examples of suitable functional reactive groups are acid groups, such as carboxyl groups, sulfonic acid groups or phosphoric acid groups, or hydroxyl groups, especially hydroxyl groups.

The nanoparticles (N′) to be modified are reacted with at least one modifier (M1).

The modifier (M1) comprises at least one functional reactive group and preferably at least two, in particular at least three, functional reactive groups (M1a) which are reactive toward the functional reactive groups of the surface to be modified. The functional reactive group (M1a) preferably contains at least one, especially one, silicon atom. Functional reactive groups (M1a) are customary and can be selected by the skilled worker on the basis of the complementary functional reactive groups on the surface to be modified.

The modifier (M1) further comprises at least one, preferably one, of the above-described inert spacer groups (G1b). These are linked covalently to the functional reactive groups (G1a).

The modifier (M1) additionally comprises at least one, especially one, of the above-described functional reactive groups (G1c), which are connected to the group (M1a) via the group (G1b) and are inert toward the functional reactive groups of the surface to be modified.

The nanoparticles for modification are further reacted with at least one modifier (M2) having a smaller hydrodynamic volume V_{H} than the modifier (M1).

The modifier (M2) comprises at least one functional reactive group (M2a) which contains at least one, especially one, silicon atom and is reactive toward the functional reactive groups of the surface to be modified.

The modifier (M2) further comprises at least one of the above-described inert groups (G2e) and preferably at least two, in particular three, groups (G2e) which is or are preferably linked directly to the functional reactive group (M2a).

The nanoparticles (N′) for modification may additionally be reacted with at least one modifier (M3).

The modifier (M3) comprises at least one, especially one, functional reactive group (M3a) which is reactive toward the functional reactive groups of the surface to be modified. In principle, the functional reactive groups (M3a) can comprise the above-described functional reactive groups (M1a). Preferably, however, the functional reactive groups (M3a) are selected from the group consisting of the precursors of the functional linker groups (G3a), preferably from ether, thioether, carboxylate, thiocarboxylate, carbonate, thiocarbonate, phosphate, thiophosphate, phosphonate, thiophosphonate, phosphite, thiophosphite, sulfonate, amide, amine, thioamide, phosphoramide, thiophosphoramide, phosphonamide, thiophosphonamide, sulfonamide, imide, hydrazide, urethane, urea, thiourea, carbonyl, thiocarbonyl, sulfone, and sulfoxide groups (G3a), particularly from ether groups (G3a). The functional reactive groups (M3a) are usual functional reactive groups of organic chemistry and can therefore be selected easily by the skilled worker on the basis of his or her art knowledge.

The modifier (M3) further comprises at least one, especially one, of the above-described inert groups (G3d) having a smaller hydrodynamic volume V_{H} than that of the above-described inert spacer group (G1 b). The group (G3d) is preferably linked directly to the reactive functional group (M3a).

The modifiers (M1) are preferably selected from the group consisting of silanes of the general formula II:
[(R²)ₒ(R³)₃₋ₒSi]ₘR(G1c)ₙ (II),
in which the indices and variables are defined as follows:
m and n are integers from 1 to 6, preferably from 1 to 5, and in particular from 1 to 3;
o is 0, 1 or 2, especially 0;
G1c is a group which can be activated thermally and/or with actinic radiation, as defined above;
R is an at least divalent organic radical, as defined above;
R² is a monovalent organic radical, as defined above; and
R³ is a hydrolyzable atom or hydrolyzable group.

The hydrolyzable atom R³ is preferably selected from the group consisting of hydrogen, fluorine, chlorine, and bromine atoms and the hydrolyzable group R³ from the group consisting of hydroxyl groups and monovalent organic radicals R⁴.

The monovalent organic radical R⁴ is preferably selected from the group consisting of groups of the general formula III:
—Y—R² (III),
in which the variable Y is an oxygen atom or a carbonyl group, carbonyloxy group, oxycarbonyl group, amino group —NH— or secondary amino group —NR²—, in particular an oxygen atom, and the variable R² is as defined above.

The hydrolyzable monovalent organic radical R⁴ is more preferably selected from the group consisting of unsubstituted alkoxy radicals having 1 to 4 carbon atoms in the alkyl radical.

The silanes (M1) are conventional compounds and can be prepared by the conventional methods of organosilicon chemistry. Preferably the silanes (M1) are obtainable by
(1) reacting polyisocyanates with blocking agents, such as those described above, and with silanes of the general formula IV:
   [(R²)ₒ(R³)₃₋ₒSi]ₘRZ (IV),
   in which the variable Z is an isocyanate-reactive functional group, preferably a hydroxyl group, a thiol group or a primary or secondary amino group, in particular a hydroxyl group, and the variables R, R² and R³ are as indicated above; or
(2) reacting compounds of the general formula V:
   (G1c)ₙR-Z (V),
   in which the index n and the variables G1c, R, and Z are as indicated above, with silanes of the general formula VI:
      [(R²)ₒ(R³)₃₋ₒSi]ₘR—NCO (VI),
   in which the index m and the variables R, R², and R³ are as indicated above.

Examples of suitable silanes of the general formula IV are known from, for example, American U.S. Pat. No. 5,998,504 A1, column 3, line 37, to column 4, line 29, or from European patent application EP 1 193 278 A1, page 3, lines 27 to 43.

Examples of suitable polyisocyanates are
diisocyanates such as isophorone diisocyanate (i.e., 5-isocyanato-1-isocyanatomethyl-1,3,3-trimethylcyclohexane), 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethan 2,4′-diisocyanate, trimethylene diisocyanate, tetramethylene diisocyanate, pentamethylene diisocyanate, hexamethylene diisocyanate (HDI), ethylethylene diisocyanate, trimethylhexane diisocyanate, heptamethylene diisocyanate or diisocyanates derived from dimer fatty acids as sold under the commercial designation DDI 1410 by Flenkel and described in patents WO 97/49745 and WO 97/49747, especially 2-heptyl-3,4-bis(9-isocyanatononyl)-1-pentylcyclohexane, or 1,2-, 1,4- or 1,3-bis(isocyanatomethyl)cyclohexane, 1,2-, 1,4- or 1,3-bis-(2-isocyanatoeth-1-yl)cyclohexane, 1,3-bis(3-isocyanatoprop-1-yl)cyclohexane, 1,2-, 1,4- or 1,3-bis(4-isocyanatobut-1-yl)cyclohexane, or liquid bis(4-isocyanatocyclohexyl)methane with a trans/trans content of up to 30% by weight, preferably 25% by weight, and in particular 20% by weight, as is described in patent applications DE 44 14 032 A1, GB 1 220 717 A1, DE 16 18 795 A1 or DE 17 93 785 A1, more preferably isophorone diisocyanate, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)-cyclohexane, 1-isocyanato-2-(3-isocyanatoeth-1-yl)cyclohexane, 1-isocyanato-2-(4-isocyanatobut-1-yl)cyclohexane or HDI, especially HDI; or
   polyisocyanates which contain isocyanurate, biuret, allophanate, iminooxadiazinedione, urethane, urea, carbodiimide and/or uretdione groups and are prepared in conventional manner from the diisocyanates described above; examples of suitable preparation processes and polyisocyanates are known from, for example, patents CA 2,163,591 A, U.S. Pat. No. 4,419,513 A, U.S. Pat. No. 4,454,317 A, EP 0 646 608 A, U.S. Pat. No. 4,801,675 A1, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A, U.S. Pat. No. 5,290,902 A, EP 0 649 806 A1, DE 42 29 183 A1 or EP 0 531 820 A1.

Further examples of suitable polyisocyanates are known from American U.S. Pat. No. 5,998,504 A, column 5, line 21, to column 6, line 2.

Particular preference is given to using isocyanurates based on isophorone diisocyanate to prepare the silanes (M1).

Examples of suitable compounds of the general formula V are glycidol and conventional, hydroxyl-containing, olefinically unsaturated monomers, such as
hydroxyalkyl esters of alpha,beta-olefinically unsaturated carboxylic acids, such as hydroxyalkyl esters of acrylic acid, methacrylic acid, and ethacrylic acid in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate or ethacrylate; 1,4-bis(hydroxymethyl)cyclohexane, octahydro-4,7-methano-1H-indenedimethanol or methylpropanediol monoacrylate, monomethacrylate, monoethacrylate or monocrotonate; or reaction products of these hydroxyalkyl esters with cyclic esters, such as epsilon-caprolactone, for example;
olefinically unsaturated alcohols such as allyl alcohol;
allyl ethers of polyols, such as trimethylolpropane monoallyl ether or pentaerythritol monoallyl, diallyl or triallyl ether;
reaction products of alpha,beta-olefinically unsaturated carboxylic acids with glycidyl esters of an alpha-branched monocarboxylic acid having 5 to 18 carbon atoms in the molecule. It is preferred to use the reaction product of acrylic and/or methacrylic acid with the glycidyl ester of Versatic® acid. This glycidyl ester is available commercially under the name Cardura® E10. For further details refer to Römpp Lexikon Lacke und Druckfarben, Georg Thieme Verlag, Stuttgart, N.Y., 1998, pages 605 and 606;
formaldehyde adducts of aminoalkyl esters of alpha,beta-olefinically unsaturated carboxylic acids and of alpha,beta-unsaturated carboxamides, such as N-methylolaminoethyl acrylate, N-methylolaminoethyl methacrylate, and N-methylolaminoethyl acrylamide and -methacrylamide; and also
olefinically unsaturated monomers containing acryloyloxysilane groups and hydroxyl groups, preparable by reacting hydroxy-functional silanes with epichlorohydrin and then reacting the intermediate with an alpha,beta-olefinically unsaturated carboxylic acid, especially acrylic acid and methacrylic acid, or, their hydroxyalkyl esters.

Examples of suitable silanes of the general formula VI are known from, for example, German patent application DE 199 10 876 A1.

The modifier (M2) is preferably selected from the group consisting of silanes of the general formula VII:
(R²)₄₋ₚSi(R³)ₚ (VII),
in which the index p=1, 2 or 3, especially 1, and the variables R² and R³ are as defined above.

Examples of suitable silanes (M2) are described in American U.S. Pat. No. 5,998,504 A, column 4, line 30 to column 5, line 20. Particular preference is given to using trimethylethoxysilane.

The modifier (M3) is preferably selected from the group consisting of hydroxyl-containing compounds of the general formula VIII:
R²—OH (VIII),
in which the variable R² is as defined above. Particular preference is given to using aliphatic, especially primary, alcohols, as described in, for example, American U.S. Pat. No. 4,652,470 A1, column 9, line 59 to column 10, line 5. n-Hexanol is used with especial preference.

Nanoparticles (N′) selected for modification can be any conventional nanoparticles. They are preferably selected from the group consisting of metals, compounds of metals, and organic compounds.

The metals are preferably selected from main groups three to five and transition groups three to six and also one and two of the periodic table of the elements and also from the lanthanides, and more preferably from the group consisting of boron, aluminum, gallium, silicon, germanium, tin, arsenic, antimony, silver, zinc, titanium, zirconium, hafnium, vanadium, niobium, tantalum, molybdenum, tungsten, and cerium. Aluminum and silicon are used in particular.

The compounds of the metals are preferably oxides, oxide hydrates, sulfates, hydroxides or phosphates, especially oxides, oxide hydrates, and hydroxides.

Examples of suitable organic compounds are lignins and starches.

The nanoparticles (N′) for modification have a primary particle size of preferably <50, more preferably from 5 to 50, and in particular from 10 to 30 nm.

Preferentially the surface-modified nanoparticles (N) are preparable by reacting the nanoparticles (N′) for modification in a first process stage with at least one, especially one, modifier (M1) and in a second process stage with at least one, especially one, modifier (M2).

Additionally the surface-modified nanoparticles (N) are also preparable by reacting the nanoparticles (N′) for modification in the first process stage with at least one, especially one, modifier (M1) and also
in the second process stage with at least one, especially one, modifier (M3) and in the third process stage with at least one, especially one, modifier (M2), or
in the second process stage with at least one, especially one, modifier (M2) and in the third process stage with at least one, especially one, modifier (M3), or
in the second process stage with at least one, especially one, modifier (M2) and with at least one, especially one, modifier (M3).

The modifiers (M1) and (M2) and also, where used, (M3) are preferably employed in an amount which is sufficient for the full or almost full coverage of the surface of the nanoparticles (N′) for modification. The modifiers (M1) and (M2) are preferably used in a weight ratio such as to give the above-described weight ratio between modifying groups (G1) and (G2).

It is additionally possible to prepare the surface-modified nanoparticles (N) by subjecting at least one, especially one, modifier (M1) of the general formula II and at least one, especially one, modifier (M2) of the general formula VII to joint hydrolysis and condensation in accordance with the sol-gel process, after which the resultant surface-modified nanoparticles (N) may be reacted further with at least one, especially one, modifier (M3) (cf. Römpp Online, Georg Thieme Verlag, Stuttgart, 2002, “sol-gel process”).

In the reaction of the silanes (M1) and (M2) with the nanoparticles (N′) for modification or to give the surface-modified nanoparticles (N) it is preferred to use conventional catalysts for the hydrolysis, such as organic and inorganic acids.

The preparation of the surface-modified nanoparticles (N) is preferably conducted in low-boiling, protic, organic solvents, such as low-boiling alcohols, especially isopropanol.

The amount of surface-modified nanoparticles (N) in the dimensionally stable particles (P) can vary very widely. The amount, based in each case on (P), is preferably from 1 to 40% by weight, more preferably from 5 to 35% by weight, and in particular from 10 to 30% by weight.

The dimensionally stable particles (P) may further comprise at least one, especially one, polymeric and/or oligomeric binder. They may additionally comprise at least one additive selected from the group consisting of crosslinking agents, color and/or effect pigments, organic and inorganic, transparent or opaque fillers, other nanoparticles different than the surface-modified nanoparticles (N), reactive diluents, UV absorbers, light stabilizers, free-radical scavengers, devolatilizers, slip additives, polymerization inhibitors, photoinitiators, initiators of free-radical or cationic polymerization, defoamers, emulsifiers, wetting agents, dispersants, adhesion promoters, leveling agents, film-forming auxiliaries, rheology control additives (thickeners), flame retardants, siccatives, dryers, antiskinning agents, corrosion inhibitors, waxes, and flatting agents, in effective amounts. The defoamers, emulsifiers, wetting agents, dispersants, rheology control additives (thickeners), and antiskinning agents are preferably present predominantly, in particular completely, in the aqueous phase (W) described below. The additives in the dimensionally stable particles (P) are selected in particular from the group consisting of crosslinking agents, reactive diluents, UV absorbers, light stabilizers, free-radical scavengers, and photoinitiators.

The physical composition of the dimensionally stable particles (P) can therefore vary very widely and is guided by the requirements of the case in hand. Examples of suitable physical compositions are known from German patent applications
DE 196 13 547 A1, column 1, line 50, to column 3, line 52;
DE 198 41 842 A1, page 3, line 45, to page 4, line 44;
DE 199 59 923 A1, page 4, line 37, to page 10, line 34, and page 1, lines 10 to 36;
DE 100 27 292 A1, page 6, para [0056] to page 12, para. [0099]; and
DE 100 27 267 A1, page 3, para., [0030], to page 13, para [0122].

Suitable for use as the continuous aqueous phase (W) are all aqueous phases such as are commonly used for preparing powder slurries. Examples of suitable aqueous phases (W) are described in German patent application DE 101 26 649 A1, page 12, para. [0099], in conjunction with page 12, para. [0110], to page 16, para. [0146], or in German patent application DE 196 13 547 A1, column 3, line 66, to column 4 line 45. The aqueous phase (W) includes in particular the thickeners described in German patent application DE 198 41 842 A1, page 4, line 45, to page 5, line 4, by means of which it is possible to establish the pseudoplastic behavior elucidated therein in the dispersions of the invention.

In terms of method the preparation of the dispersions of the invention presents no peculiarities but can instead be accomplished by means of the conventional processes of the prior art: the dimensionally stable particles (P) described above are dispersed in the continuous aqueous phase (W), the surface-modified nanoparticles (N) being mixed with the remaining constituent(s) of the dimensionally stable particles (P) and the resultant mixture (P) being dispersed in the aqueous phase (W).

The dispersions of the invention can be prepared, by way of example, by first producing a powder coating material (P) from the constituents of the dimensionally stable particles (P), by extrusion and grinding, and then wet-grinding said powder coating material (P) in water or in an aqueous phase (W), as described in, for example, German patent applications DE 196 13 547 A1, DE 196 18 657 A1, DE 198 14 471 A1 or DE 199 20 141 A1.

The dispersions of the invention can also be prepared by means of what is termed the secondary dispersion process, in which the constituents of the particles (P) and also water are emulsified in an organic solvent to give an oil-in-water emulsion, after which the organic solvent is removed from said emulsion, causing the emulsified droplets (P) to solidify, as is described in, for example, German patent applications DE 198 41 842 A1, DE 100 01 442 A1, DE 100 55 464 A1, DE 101 35 997 A1, DE 101 35 998 A1 or DE 101 35 999 A1.

The dispersions of the invention may also be prepared by means of what is known as the primary dispersion process, in which olefinically unsaturated monomers are polymerized in an emulsion, as is described in, for example, German patent application DE 199 59 923 A1. In addition to the constituents described therein the emulsion comprises, in accordance with the invention, the surface-modified nanoparticles (N).

The dispersions of the invention may be prepared, furthermore, by means of what is known as the melt emulsification process, where a melt of the constituents of the particles (P) is introduced into an emulsifying apparatus, preferably with the addition of water and stabilizers, and the resulting emulsion of the droplets (P) is cooled, so as to give a suspension of the particles (P) which is filtered, as is known from, for example, German patent applications DE 100 06 673 A1, DE 101 26 649 A1, DE 101 26 651 A1 or DE 101 26 652 A1.

In particular, the dispersions of the invention are prepared by the secondary dispersion process.

For the preparation of the dispersions of the invention it is possible to use the as prepared surface-modified nanoparticles (N). In accordance with invention, however, it is of advantage to use the preparation process of the invention to prepare the dispersions of the invention.

In the preparation process of the invention the surface-modified nanoparticles (N) are used in the form of their dispersions (D) in aprotic, especially aprotic apolar, liquid, organic media (O).

The aprotic, liquid, organic media (O) are preferably composed essentially or entirely of aprotic, especially aprotic apolar, solvents and/or reactive diluents.

By aprotic solvents are meant organic solvents which contain no protolyzable hydrogen atoms; i.e., they are not proton donors. For further details on this refer to Römpp Lexikon Lacke und Druckfarben, Georg Thieme Verlag, Stuttgart, N.Y. 1998, page 41, “aprotic solvents”, or Römpp Online, Georg Thieme Verlag, Stuttgart, N.Y., 2002, “aprotic solvents”. Examples of suitable aprotic solvents are known from the book by Dieter Stoye and Werner Freitag (editors), “Paints, Coatings and Solvents”, second, completely revised edition, Wiley-VCH, Weinheim, N.Y., 1998, pages 327 to 373.

By reactive diluents are meant reactive diluting agents or reactive solvents, which is a simplified term for the longer designation according to DIN 55945: 1996-09, which describes diluents which, through chemical reaction, become part of the binder in the course of film formation. The chemical reaction may be initiated thermally or by means of actinic radiation. Accordingly, there can be reactive diluents for thermal crosslinking, reactive diluents for crosslinking with actinic radiation, or reactive diluents for thermal crosslinking and crosslinking with actinic radiation.

Examples of suitable reactive diluents for thermal crosslinking are branched, cyclic and/or, acyclic C₉-C₁₆ alkanes functionalized with at least two hydroxyl or thiol groups or with at least one hydroxyl and at least one thiol group, especially diethyloctanediols.

Further examples of suitable reactive diluents for thermal crosslinking are oligomeric polyols obtainable by hydroformylation and subsequent hydrogenation from oligomers themselves obtained by metathesis reactions of acyclic monoolefins and cyclic monoolefins; examples of suitable cyclic monoolefins are cyclobutene, cyclopentene, cyclohexene, cyclooctene, cycloheptene, norbornene or 7-oxanorbornene; examples of suitable acyclic monoolefins are present in hydrocarbon mixtures obtained in petroleum processing by cracking (C₅ cut); examples of suitable oligomeric polyols have a hydroxyl number (OHN) of from 200 to 450, a number-average molecular weight. Mn of from 400 to 1 000, and a mass-average molecular weight. M_{w} of from 600 to 1 100.

Examples of suitable reactive diluents for crosslinking with actinic radiation are described in detail in Römpp Lexikon Lacke und Druckfarben, Georg Thieme Verlag, Stuttgart, N.Y., 1998, “reactive diluents”, pages 491 and 492, in German patent application DE 199 08 013 A1, column 6, line 63, to column 8, line 65, in German patent application DE 199 08 018 A1, page 11, lines 31 to 33, in German patent application DE 198 18 735 A1, column 7, lines 1 to 35, or in German patent DE 197 09 467 C1, page 4, line 36, to page 5, line 56. Preference is given to using pentaerythritol tetraacrylate and/or aliphatic urethane acrylates having six acrylate groups in the molecule.

Examples of suitable reactive diluents for thermal crosslinking and crosslinking with actinic radiation are described in detail in European patent application EP 0 928 800 A1, page 3, lines 17 to 54, and page 4, lines 41 to 54, or in German patent application DE 198 18 735 A1, column 3, line 16, to column 6, line 33.

With particular preference the aprotic solvents and/or reactive diluents, in terms of the modifying groups (G1) and, where used, (G3), have a Flory-Huggins parameter χ>0.5 (cf. in this context K. Kehr, Mittlere Feldtheorie von Polymerlösungen, Schmeizen und Mischungen, Random Phase Approximation, in Physik der Polymere, 22nd IFF-Ferienkurs, Forschungszentrum Jülich GmbH, Jülich, 1991).

The dispersions (D), based on their total amount, preferably have a solids content >30, more preferably >40, and in particular >50% by weight, without any sedimentation or gelling occurring.

The transfer of the surface-modified nanoparticles (N) to the aprotic, liquid, organic media (O), preferably to the aprotic, and especially the aprotic apolar, solvents or reactive diluents is accomplished by means of a distillation. The aprotic solvents and/or reactive diluents are therefore to be selected such that they do not go over during the distillation. In order to optimize the process it is possible to use certain azeotrope formers, which form low-boiling azeotropes with the protic solvents used in the preparation of the surface-modified nanoparticles (N). The process enables dispersions (D) to be prepared which have a residual protic solvent content of less than 1% by weight (by GC analysis).

Dispersions (D) may further comprise at least one of the additives described above. They are preferably free from said additives.

Preparation of the dispersions (D) requires no peculiarities in terms of method but instead takes place in accordance with the conventional methods of preparing dispersions, by mixing of the above-described constituents in suitable mixing equipment such as stirred tanks, dissolvers, inline dissolvers, mills with stirrer mechanisms, or extruders.

In the preparation process of the invention the dispersions (D) are mixed with the remaining constituents of the dimensionally stable particles (P). The resultant mixtures (P) are dispersed in aqueous phases (W) so as to form the dimensionally stable particles (P). The preparation process of the invention can be carried out with the aid of the above-described processes for preparing the dispersions of the invention; the secondary dispersion process is employed in particular.

The dispersions of the invention are outstandingly suitable for use as coating materials, adhesives, and sealants. In particular they are outstandingly suitable for the coating, adhesive bonding, and sealing of bodies of means of transport of any kind (especially means of transport operated by muscle power, such as cycles, carriages or railroad trolleys, aircraft, such as airplanes or airships, floating structures, such as ships or buoys, rail vehicles, and motor vehicles, such as motorcycles, buses, trucks or automobiles) or of parts thereof; of the interior and exterior of constructions; of furniture, windows, and doors; of small industrial parts, of coils, containers, and packaging; of white goods; of sheets; of optical, electrical, and mechanical components, and also of hollow glassware and articles of everyday use.

They are preferably used as coating materials, more preferably as powder slurry clearcoat materials. They are especially suitable for producing clearcoats as part of multicoat color and/or effect paint systems, in particular by the wet-on-wet technique, as is described in, for example, German patent application DE 100 27 292 A1, page 13, para, [0109], to page 14, para [0118].

Like the conventional powder slurries, the dispersions of the invention can also be applied to the substrates in question by means of conventional spray application techniques, as is described in, for example, German patent application DE 100 27 292 A1, page 14, paras. [0121] to [0126].

The curing methods employed in each case are oriented on the physical composition of the dispersions of the invention and can be conducted, for example, as described in German patent application DE 100 27 292 A1, page 14, para., [0128], to page 15, para. [0136].

In all applications the applied dispersions of the invention, following their curing, give coatings, adhesive layers, and seals which even at high film thicknesses exhibit no surface defects, in particular no pocks, no longer exhibit any blushing following moisture exposure, and have outstanding hardness, scratch resistance, adhesion, and chemical stability. Furthermore, the coatings, adhesive layers, and seals can be overcoated entirely without problems, which is especially important for the purpose, for example, of automotive refinish.

### EXAMPLES

### Preparation Example 1

The Preparation of the Modifier (M1)

80.2 g of a partly blocked and approximately 40% silanized isophorone diisocyanate trimer in accordance with preparation example 1 of European patent application EP 1 193 278 A1 were introduced together with 13.97 g of 3,5-dimethylpyrazole into a three-necked flask with reflux condenser and thermometer and were heated to 50° C. with stirring. The conversion in the reaction was monitored by means of IR spectroscopy. After 13 hours the blocking reaction was complete; free isocyanate groups were no longer detectable by IR spectroscopy.

### Preparation Example 2

The Preparation of Surface-Modified Nanoparticles (N) and Their Dispersion (D) in an Aprotic Organic Solvent and a Reactive Diluent for Crosslinking with UV Radiation

31.7 parts by weight of the modifier M1 from preparation example 1 were heated to 70° C. and slowly admixed with 42.5 parts by weight of a colloidal solution of SiO₂ in isopropanol (IPA-ST-S, obtainable from Nissan Chemical) and with 2.9 parts by weight of 0.1 N acetic acid. The mixture obtained in this way was stirred at 70° C. for another 3 hours and then slowly admixed dropwise over a period of at least 30 minutes with 2 parts by weight of trimethylethoxysilane. Subsequently 10.3 parts by weight of solvent naphtha and 1.6 parts by weight of hexanol were added and the solution obtained was stirred at 70° C. for 3 hours more. Subsequently 29.8 parts by weight of a commercial aliphatic urethane acrylate having six acrylate groups in the molecule (Ebecryl® 1290 from UCB) were added.

In order to separate off low-boiling constituents the cooled reaction mixture was separated from the low-boiling constituents on a rotary evaporator at a bath temperature of not more than 65° C. in vacuo.

The resulting dispersion of the surface-modified nanoparticles (N) in the reactive diluent was then admixed with methyl ethyl ketone so as to give a dispersion (D) with a solids content of 80% by weight. The Ebecryl® 1230 content was 29.8% by weight. The blocked isocyanate group content was 1.9% by weight. The dispersion (D) had an ignition residue of 14.6% by weight and was stable at room temperature for a period of at least 3 months, without any observable increase in viscosity.

### Preparation Example 3

The Preparation of a Blocked Polyisocyanate

A suitable laboratory reactor equipped with stirrer, reflux condenser, thermometer, and nitrogen inlet tube was charged with 1.068 parts by weight of a commercial polyisocyanate (isocyanurate based on hexamethylene diisocyanate, Desmodur® N 3300 from Bayer AG) and 380 parts by weight of methyl ethyl ketone and this initial charge was slowly heated to 40° C. Subsequently a total of 532 parts by weight of 2,5-dimethylpyrazole were added in portions in a manner such that the temperature of the reaction mixture did not climb higher than 80° C. The reaction mixture was held at 80° C. until free isocyanate was no longer detectable, and subsequently cooled. The resulting solution of the blocked polyisocyanate had a solids content of 79.3% by weight.

### Example 1

### The Preparation of a Pseudoplastic Aqueous Dispersion of Dimensionally Stable Particles (P)

A suitable glass stirred vessel equipped with a high-speed stirrer was charged with 194.17 parts by weight of the methyl ethyl ketone solution of a methacrylate copolymer (A) such as is commonly used as a binder in coating materials (solids content: 57.6% by weight in methyl ethyl ketone; acid number: 29 mg KOH/g resin solids; hydroxyl number: 150 mg KOH/g resin solids; OH equivalent weight: 374 g/mol), 81.87 parts by weight of the solution of the blocked polyisocyanate from preparation example 3, 83.89 parts by weight of dispersion (D) from preparation example 2, and 2.07 parts by weight of dimethylethanolamine and these components were mixed intensively with one another. Added to the resultant mixture were 1 part by weight of a photoinitiator mixture consisting of Irgacure® 184 (commercial photoinitiator from Ciba Specialty Chemicals) and Lucirin® TPO (commercial photoinitiator from BASF AG) in a weight ratio of 5:1, 2.32 parts by weight of a commercial UV absorber (Tinuvin® 400), and 2.32 parts by weight of a commercial reversible free-radical scavenger (HALS; Tinuvin® 123), which were likewise mixed in thoroughly. This gave the mixture (P).

Deionized water in an amount corresponding to a target solids content of from 36 to 37% by weight for the pseudoplastic aqueous dispersion was added slowly with stirring (about 422 parts by weight) to the mixture (P). After all of the water had been added the resultant dispersion was filtered through 1 μm Cuno® pressure filters. The methyl ethyl ketone was subsequently distilled off in vacuo at a maximum of 35° C.

The dispersion was completed by adding 0.33 part by weight of a commercial leveling agent (Baysilone® A13468 from Bayer AG) and 19.67 parts by weight of a commercial thickener (Acrysol® RM-8W from Rohm & Haas). Finally it was filtered through 1 μm Cuno® pressure filters.

The pseudoplastic aqueous dispersion had a solids content of 36.2% by weight and was stable on storage and easy to apply.

### Example 2

The Production of a Multicoat Color Paint System Using the Pseudoplastic Aqueous Dispersion of Example 1

The pseudoplastic aqueous dispersion of example 1 was applied pneumatically using a gravity-feed cup-type gun to steel panels which had been precoated with—one above the other in the order stated—an electrocoat, a surfacer coat, and a black aqueous basecoat. The wet film thickness of the applied films was chosen so that the cured clearcoats had a dry film thickness of 40 μm. The applied films were flashed off at room temperature for 10 minutes, dried at 60° C. for 5 minutes, and cured thermally at 150° C. for 30 minutes. Thermal curing was carried out using convection ovens from Heraeus.

The table gives an overview of the conventional tests conducted and the results obtained. These results underline the fact that the novel clearcoats of example 2 had a particularly high surface hardness and a particularly high scratch resistance. At the same time they were clear and of high gloss, free from surface defects, such as craters, inhomogeneities, and microbubbles, resistant to chemicals, and of high adhesive strength. Not least they possessed very good polishability.

TABLE
Performance properties of the clearcoats of example 2

| Test | Results |
|---|---|
| leveling (visual) | satisfactory |
| craters (visual) | none |
| pocks (visual) | none |
| gloss 20° (units) | 85 |
| haze (units) | 9 |
| MB scratch test (rating) | 2 |
| Sand test: | |
| Gloss 20° (units): | |
| unexposed | 85 |
| after exposure | 63 |
| Reflow: | |
| after 2 hours at room temperature | 63 |
| after 2 hours at 40° C. | 65 |
| after 2 hours at 60° C. | 71 |
| Rotahub test: | |
| Gloss 20° (units): | |
| unexposed | 85 |
| after exposure | 77 |
| residual gloss (%) | 90.5 |
| Micropenetration hardness: | |
| universal hardness at 25.6 mN | 125 |
| [N/mm²] | |
| standard deviation | 0.77 |
| mean penetration depth (μm) | 2.29 |
| relative elastic resilience | 43 |
| creep at 25.6 mN | 15.88 |
| creep at 0.4 mN | 20.27 |
| Daimler Chrysler gradient oven | |
| (° C. above which damage begins): | |
| sulfuric acid | 45 |
| water | >70 |
| pancreatin | 40 |
| tree resin | 45 |
| Stonechip resistance: | |
| ball shot: | 4/1 |
| flaking (mm²)/rusting | |
| VDA DB stonechip, 2 bar: | 1.5/0.5 |
| flaking (mm²)/rusting | |
| Adhesion: | |
| adhesive tape tearoff (rating) | 0 |
| crosshatch (2 mm) (rating) | GT0 |

1. A pseudoplastic aqueous dispersion comprising particles (P) which are solid and/or of high viscosity, are dimensionally stable under storage and application conditions, are in dispersion in a continuous aqueous phase (W), and comprise surface-modified nanoparticles (N) whose surface is covered fully or almost fully by
(G1) modifying groups which
are attached covalently to the surface via functional linker groups (a) and
comprise inert spacer groups (b) and
comprise functional reactive groups (c) which are attached via the groups (b) to the groups (a) and are inert toward the functional reactive groups of the surface to be modified, and
(G2) modifying groups which
are attached to the surface via functional linker groups (a) containing at least one silicon atom,
comprise inert groups (e), and
have a smaller hydrodynamic volume V_{H} than the modifying groups (G1).

2. The pseudoplastic aqueous dispersion as claimed in claim 1, wherein the surface of the nanoparticles (N) is additionally covered by
(G3) modifying groups which
are attached covalently to the surface via at least one functional linker group (a) and
comprise at least one inert group (d) which is attached to the surface via the group (a) and has a smaller hydrodynamic volume V_{H} than the inert spacer group (G1b).

3. The pseudoplastic aqueous dispersion as claimed in claim 1, wherein the hydrodynamic volume V_{H} can be determined by at least one of means of photon correlation spectroscopy or can be estimated from the relationship
V_{H}=(r_{cont}/2)³,
in which r_{cont} is the effective contour length of a molecule.

4. The pseudoplastic aqueous dispersion as claimed in claim 1, wherein the functional reactive groups of the surface to be modified are hydroxyl groups.

5. The pseudoplastic aqueous dispersion as claimed in claim 1, wherein the functional linker group (G1 a) contains at least one silicon atom.

6. The pseudoplastic aqueous dispersion as claimed in claim 1, wherein the inert spacer group (G1b) is an at least divalent organic radical R.

7. The pseudoplastic aqueous dispersion as claimed in claim 1, wherein the functional reactive group (G1c) can be activated thermally and/or with actinic radiation.

8. The pseudoplastic aqueous dispersion as claimed in claim 7, wherein the thermally activatable functional reactive group (G1c) is a blocked isocyanate group and the functional reactive group (G1c) which can be activated with actinic radiation is selected from the group consisting of groups containing at least one carbon-carbon multiple bond.

9. The pseudoplastic aqueous dispersion as claimed in claim 2, wherein the functional linker group (G3a) is selected from the group consisting of ether, thioether, carboxylate, thiocarboxylate, carbonate, thiocarbonate, phosphate, thiophosphate, phosphonate, thiophosphonate, phosphite, thiophosphite, sulfonate, amide, amine, thioamide, phosphoramide, thiophosphoramide, phosphonamide, thiophosphonamide, sulfonamide, imide, hydrazide, urethane, urea, thiourea, carbonyl, thiocarbonyl, sulfone, and sulfoxide groups.

10. The pseudoplastic aqueous dispersion as claimed in claim 1, wherein the inert group (G3d) and the inert group (G2e) are monovalent organic radicals R².

11. The pseudoplastic aqueous dispersion as claimed in claim 10, wherein the monovalent organic radicals R² are selected from the group consisting of aliphatic, cycloaliphatic, aromatic, aliphatic-cycloaliphatic, aliphatic-aromatic, cycloaliphatic-aromatic and aliphatic-cycloaliphatic-aromatic radicals.

12. The pseudoplastic aqueous dispersion as claimed in claim 1, wherein the inert groups (G1b), (G2e) and (G3d) contain at least one of an at least divalent functional group and at least one substituent.

13. The pseudoplastic aqueous dispersion as claimed in claim 1, wherein the surface-modified nanoparticles (N) are prepared by reacting the functional reactive groups of the surface of nanoparticles (N′) for modification with
(M1) at least one modifier comprising
at least one functional reactive group (Mia) which is reactive toward the functional reactive groups of the surface to be modified,
at least one inert spacer group (G1b), and
at least one functional reactive group (G1c) which is attached to the group (M1a) via the group (G1b) and which is inert toward the functional reactive groups of the surface to be modified, and
(M2) at least one modifier having a smaller hydrodynamic volume V_{H} than the modifier (M1) and comprising
at least one functional reactive group (M2a) which contains at least one silicon atom and is reactive toward the functional reactive groups of the surface to be modified, and
at least one inert group (G2e).

14. The pseudoplastic aqueous dispersion as claimed in claim 13, wherein the surface-modified nanoparticles (N) are prepared by additionally reacting the functional reactive groups of the surface of nanoparticles (N′) for modification with
(M3) at least one modifier comprising
at least one functional reactive group (M3a) which is reactive toward the functional reactive groups of the surface to be modified, and
at least one inert group (G3d) having a smaller hydrodynamic volume V_{H} than the inert spacer group (G1b).

15. The pseudoplastic aqueous dispersion as claimed in claim 13, wherein the modifier (M1) is selected from the group consisting of silanes of the general formula II:
[(R²)ₒ(3)₃₋ₒSi]ₘR(G1c)ₙ (II),
in which the indices and variables are defined as follows:
m and n are integers from 1 to 6;
o is 0, 1 or 2;
G1c is a group which can be activated thermally and/or with actinic radiation;
R is an at least divalent organic radical;
R² is a monovalent organic radical, as above selected from the group consisting of aliphatic, cycloaliphatic, aromatic, aliphatic-cycloaliphatic, aliphatic-aromatic, cycloaliphatic-aromatic and aliphatic-cycloaliphatic-aromatic radicals; and
R³ is a hydrolyzable atom or hydrolyzable group.

16. The pseudoplastic aqueous dispersion as claimed in claim 15, wherein the hydrolyzable atom R is selected from the group consisting of hydrogen, fluorine, chlorine, and bromine atoms and the hydrolyzable group R³ is selected from the group consisting of hydroxyl groups and monovalent organic radicals R⁴.

17. The pseudoplastic aqueous dispersion as claimed in claim 16, wherein the monovalent organic radical R⁴ is selected from the group consisting of groups of the general formula III:
—Y—R² (III),
in which the variable Y is an oxygen atom or a carbonyl group, carbonyloxy group, oxycarbonyl group, amino group —NH— or secondary amino group —NR²— and the variable R² is a monovalent organic radical selected from the group consisting of aliphatic, cycloaliphatic, aromatic, aliphatic-cycloaliphatic, aliphatic-aromatic, cycloaliphatic-aromatic and aliphatic-cycloaliphatic-aromatic radicals.

18. The pseudoplastic aqueous dispersion as claimed in claim 13, wherein the silanes (M1) of the general formula II are obtained by
(1) reacting polyisocyanates with blocking agents and with silanes of the general formula IV:
[(R²)ₒ(R³)₃₋ₒSi]ₘRZ (IV),
in which the variable Z is an isocyanate-reactive functional group and wherein
R is an at least divalent organic radical:
R² is a monovalent organic radical; and
R³ is a hydrolyzable atom or hydrolyzable group; and
(2) reacting compounds of the general formula V:
(G1c)ₙR-Z (V),
in which the index n and the variables G1c, R and Z are as indicated above, with silanes of the general formula VI:
[(R²)ₒ(R³)₃₋ₒSi]ₘR—NCO (VI),
in which the index m and the variables R, R¹ and R³ are as indicated above.

19. The pseudoplastic aqueous dispersion as claimed in claim 13 to 18, wherein the modifier (M2) is selected from the group consisting of silanes of the general formula VII:
(R²)₄₋ₚSi(R³)ₚ (VII),
in which the index p=1, 2 or 3 and wherein
R² is a monovalent organic radical; and
R³ is a hydrolyzable atom or hydrolyzable group.

20. The pseudoplastic aqueous dispersion as claimed in claim 14, wherein the modifier (M3) is selected from the group consisting of hydroxyl-containing compounds of the general formula VIII:
R²—OH (VIII),
in which the variable R² monovalent organic radicals.

21. The pseudoplastic aqueous dispersion as claimed in claim 20, wherein the hydroxyl-containing compounds of the general formula VIII are primary aliphatic alcohols.

22. The pseudoplastic aqueous dispersion as claimed in claim 1, wherein the nanoparticles (N′) for modification are selected from the group consisting of metals, compounds of metals, and organic compounds and mixtures thereof.

23. The pseudoplastic aqueous dispersion as claimed in claim 22, wherein the metals are selected from main groups three to five, transition groups three to six, groups one and two of the periodic table of the elements and from the lanthanides.

24. The pseudoplastic aqueous dispersion as claimed in claim 22, wherein the compounds of the metals are at least one of oxides, oxide hydrates, sulfates, hydroxides and phosphates.

25. The pseudoplastic aqueous dispersion as claimed in claim 1, wherein the surface-modified nanoparticles (N) are prepared by reacting the nanoparticles (N′) for modification in a first process stage with at least one modifier (M1) and in a second process stage with at least one modifier (M2).

26. The pseudoplastic aqueous dispersion as claimed in claim 25, wherein the surface-modified nanoparticles (N) are prepared by reacting the nanoparticles (N′) for modification in the first process stage with a modifier (M1) and also
in the second process stage with at least one modifier (M3) and in the third process stage with at least one modifier (M2), or
in the second process stage with at least one modifier (M2) and in the third process stage with at least one modifier (M3), or
in the second process stage with at least one modifier (M2) and with at least one modifier (M3).

27. The pseudoplastic aqueous dispersion as claimed in claim 25, wherein the modifiers (M1) and (M2) and also, where used, (M3) are employed in an amount which is sufficient for the full or almost full coverage of the surface of the nanoparticles (N′) for modification.

28. The pseudoplastic aqueous dispersion as claimed in claim 15, wherein the surface-modified nanoparticles (N) are prepared by subjecting at least one modifier (M1) of the general formula II and at least one modifier (M2) of the general formula VII to joint hydrolysis and condensation

29. The pseudoplastic aqueous dispersion as claimed in claim 28, wherein the surface-modified nanoparticles (N) are preparable by additionally reacting the resultant surface-modified nanoparticles (N) with at least one modifier (M3).

30. The pseudoplastic aqueous dispersion as claimed in claim 1, wherein the dimensionally stable particles (P) comprise the surface-modified nanoparticles (N) in an amount of from 1 to 40% by weight, based on (P).

31. The pseudoplastic aqueous dispersion as claimed in claim 1, wherein the dimensionally stable particles (P) comprise at least one polymeric and/or oligomeric binder.

32. The pseudoplastic aqueous dispersion as claimed in claim 1, comprising in the dimensionally stable particles (P) and/or in the aqueous phase (W) at least one additive selected from the group consisting of crosslinking agents, color and/or effect pigments, organic pigments, inorganic pigments, transparent fillers, opaque fillers, other nanoparticles different than the surface-modified nanoparticles (N), reactive diluents, UV absorbers, light stabilizers, free-radical scavengers, devolatilizers, slip additives, polymerization inhibitors, photoinitiator's, initiators of free-radical polymerization, initiators of cationic polymerization, defoamers, emulsifiers, wetting agents, dispersants, adhesion promoters, leveling agents, film-forming auxiliaries, rheology control additives (thickeners), flame retardants, siccatives, dryers, antiskinning agents, corrosion inhibitors, waxes, and flatting agents.

33. The pseudoplastic aqueous dispersion as claimed in claim 1, comprising the dimensionally stable particles (P) in an amount of from 5 to 70% by weight, based on the pseudoplastic aqueous dispersion.

34. A process for preparing a pseudoplastic aqueous dispersion as claimed in claim 1, which comprises mixing at least one dispersion (D) of surface-modified nanoparticles (N) whose surface is covered fully or almost fully by modifying groups (G1) and modifying groups (G2) in an aprotic, liquid, organic medium (O) with the remaining constituents of the dimensionally stable particles (P) and dispersing the resultant mixture (P) in an aqueous phase (W) so as to give the dimensionally stable particles (P).

35. The process as claimed in claim 34, wherein the surface of the surface-modified nanoparticles (N) is additionally covered by modifying groups (G3).

36. The process as claimed in claim 34, wherein the aprotic, liquid, organic medium (O) comprises or comprises at least one of an aprotic organic solvent and reactive diluent.

37. The process as claimed in claim 36, wherein the aprotic organic solvents and/or reactive diluents, in terms of the modifying groups (M1) and, where used, (M3), have a Flory-Huggins parameter χ>0.5.

38. The process as claimed in claims 34, wherein the dispersion (D) has a surface-modified nanoparticle (N) content of at least 30% by weight.

39. (canceled)

40. A composition comprising the aqueous pseudoplastic dispersion claimed in claim 1, comprising at least one of a coating material, adhesive or sealant.
